(19) United States
(12) Patent Application Publication
(10) Pub. No.: US 2011/0073604 A1
(43) Pub. Date: Mar. 31, 2011

(54) VACUUM THERMAL INSULATOR AND THERMALLY INSULATING BOX INCLUDING THE VACUUM THERMAL INSULATOR

(75) Inventors: Kyoko NOMURA, Tokyo (JP); Syuichi Iwata, Tokyo (JP); Tsukasa Takagi, Tokyo (JP)

(73) Assignee: MITSUBISHI ELECTRIC CORPORATION, Tokyo (JP)

(21) Appl. No.: 12/888,502

(22) Filed: Sep. 23, 2010

(30) Foreign Application Priority Data
Sep. 29, 2009 (JP) 2009-224116

(51) Int. Cl. A47J 41/02; B32B 1/06

(52) U.S. Cl. 220/592.27; 428/69

(57) ABSTRACT

A vacuum thermal insulator includes a container having a gas barrier property and a core member placed in the container, the container being sealed such that the interior of the container is in a reduced pressure state. The core member is constituted by a sheet assembly in which organic fiber aggregates, each obtained by forming fibers composed of an organic material into a sheet-like shape, and fiber aggregates, each obtained by forming fibers composed of a material having a higher tensile modulus than the material for the organic fiber aggregates into a sheet-like shape, are randomly stacked. The fibers of the organic fiber aggregates are preferably continuous fibers. The fiber material for the organic fiber aggregates or the fiber aggregates is preferably any one of polyester, polypropylene, polystyrene, polylactic acid, aramid, LCP, and glass.

### BACKGROUND OF THE INVENTION

1. Field of the Invention

The present invention relates to a vacuum thermal insulator and a thermally insulating box including the vacuum thermal insulator, and more particularly, relates to a vacuum thermal insulator suitable for equipment for cooling and heating in use and a thermally insulating box including the vacuum thermal insulator.

2. Description of the Related Art

Urethane has long been used as thermal insulators. In recent years, vacuum thermal insulators having higher thermally insulating performance than that of urethane have started to be used together with urethane. Such vacuum thermal insulators are used for refrigerators, and also used for equipment for cooling and heating, such as heating chamber, vehicle air conditioners, and water heaters.

A vacuum thermal insulator has a structure including an enveloping member which is composed of an aluminum foil having a gas barrier property (air barrier property) or the like, and a core member composed of a powder, a foam, a fiber material, or the like inserted into the enveloping member. The interior of the enveloping member is maintained at a degree of vacuum of several pascals. There may be a case where the thermally insulating performance of the vacuum thermal insulator decreases because of air and moisture entering from the ambient air, gas released by outgassing from the core member, moisture present in the core member, etc., and in order to adsorb these substances, an adsorbent is inserted into the enveloping member.

Examples of the core member of the vacuum thermal insulator include a powder such as silica powder, foams such as a urethane foam, and fiber materials such as a glass fiber material. Currently, fiber materials which are most excellent in terms of thermally insulating performance are predominantly used.

Fiber materials include inorganic fibers and organic fibers. Examples of inorganic fibers include glass fibers and carbon fibers (for example, refer to Japanese Unexamined Patent Application Publication No. 8-028776 (pp. 2-3): Patent Document 1 and Japanese Unexamined Patent Application Publication No. 2005-344870 (p. 7, FIG. 2): Patent Document 8). Examples of organic fibers include polystyrene fibers, polypropylene fibers, polylactic acid fibers, aramid fibers, LCP (liquid crystal polymer) fibers, polyethylene terephthalate fibers, polyester fibers, polyethylene fibers, and cellulose fibers (for example, refer to Japanese Patent No. 3656028 (p. 5, FIG. 1): Patent Document 2, Japanese Unexamined Patent Application Publication No. 2006-283817 (pp. 7-8): Patent Document 7, and Japanese Patent No. 4012903 (p. 3): Patent Document 9).

Examples of the arrangement of fiber materials include a flocculus-like arrangement and an arrangement obtained by stacking sheets (for example, refer to Japanese Unexamined Patent Application Publication No. 2005-344832 (pp. 3-4, FIG. 1): Patent Document 3 and Japanese Unexamined Patent Application Publication No. 2006-307921 (pp. 5-6, FIG. 2): Patent Document 4). Examples of the arrangement obtained by stacking sheets include one in which sheets are stacked such that their fiber orientations alternate (refer to Japanese Unexamined Patent Application Publication No. 2006-017151 (p. 3, FIG. 1): Patent Document 5 and Japanese Examined Patent Application Publication No. 7-103955 (p. 2, FIG. 2): Patent Document 6).

Furthermore, as a core member of a vacuum thermal insulator, a core member has been disclosed that includes a thermally insulating layer composed of inorganic fibers or a foamed resin and a shape-retention member stacked on the thermally insulating layer, the shape-retention member having a higher stiffness than the thermally insulating layer and having plastic deformability (refer to Japanese Unexamined Patent Application Publication No. 2007-46628 (p. 2, FIG. 1): Patent Document 10).

### SUMMARY OF THE INVENTION

In Patent Documents 1 to 10, when performing vacuum thermal insulation, organic fibers, such as polyester or polypropylene fibers, or inorganic fibers, such as glass fibers, are used as core members. In the case where organic fibers are used as a core member, although organic fibers are suitable as the material for the core member because of their low thermal conductivity, since they have low stiffness and easily bent, the void ratio decreases. Therefore, it is difficult to increase thermally insulating performance. In the case where glass fibers are used as a core member, since glass fibers have high stiffness and do not easily bend, the void ratio can be increased. Although some glass fibers may have high thermally insulating performance, glass as a material intrinsically has high thermal conductivity. Therefore, glass fibers are not considered to be an optimum material to be selected.

The present invention has been achieved in order to solve the problems described above. It is an object of the present invention to provide a vacuum thermal insulator which takes advantages of constituent fiber materials in a synergistic manner and which is excellent in terms of thermally insulating performance, and a thermally insulating box including the vacuum thermal insulator.

In an aspect of the present invention, a vacuum thermal insulator includes a container having a gas barrier property and a core member placed therein, the container being sealed such that the interior of the container is in a decompressed state. The core member is constituted by a sheet assembly in which organic fiber aggregates, each obtained by forming fibers composed of an organic material into a sheet-like shape, and fiber aggregates, each obtained by forming fibers composed of a material having a higher tensile modulus than the material for the organic fiber aggregates into a sheet-like shape, are randomly stacked.

In another aspect of the present invention, a thermally insulating box includes an outer box and an inner box which is disposed inside the outer box, wherein the vacuum thermal insulator described above is disposed between the outer box and the inner box.

According to the present invention, since a sheet assembly is configured to include organic fiber aggregates having low thermal conductivity and fiber aggregates having a high tensile modulus (i.e., having stiffness), the void ratio of the organic fiber aggregates having low thermal conductivity increases, and the thermally insulating performance of the sheet assembly improves. Thus, it is possible to obtain a vacuum thermal insulator which is excellent in terms of thermally insulating performance. Furthermore, it is possible to obtain a thermally insulating box having excellent thermally insulating properties.

### BRIEF DESCRIPTION OF THE DRAWINGS

FIG. 1 is a perspective view of a vacuum thermal insulator according to Embodiment 1 of the present invention;

FIG. 2 is an exploded perspective view of the vacuum thermal insulator shown in FIG. 1;

FIG. 3 is a schematic view illustrating the stacking state in a core member of the vacuum thermal insulator shown in FIG. 1; and

FIG. 4 is a cross-sectional view schematically showing a thermally insulating box according to Embodiment 2 of the present invention.

### DESCRIPTION OF THE PREFERRED EMBODIMENTS

### Embodiment 1

### Vacuum Thermal Insulator

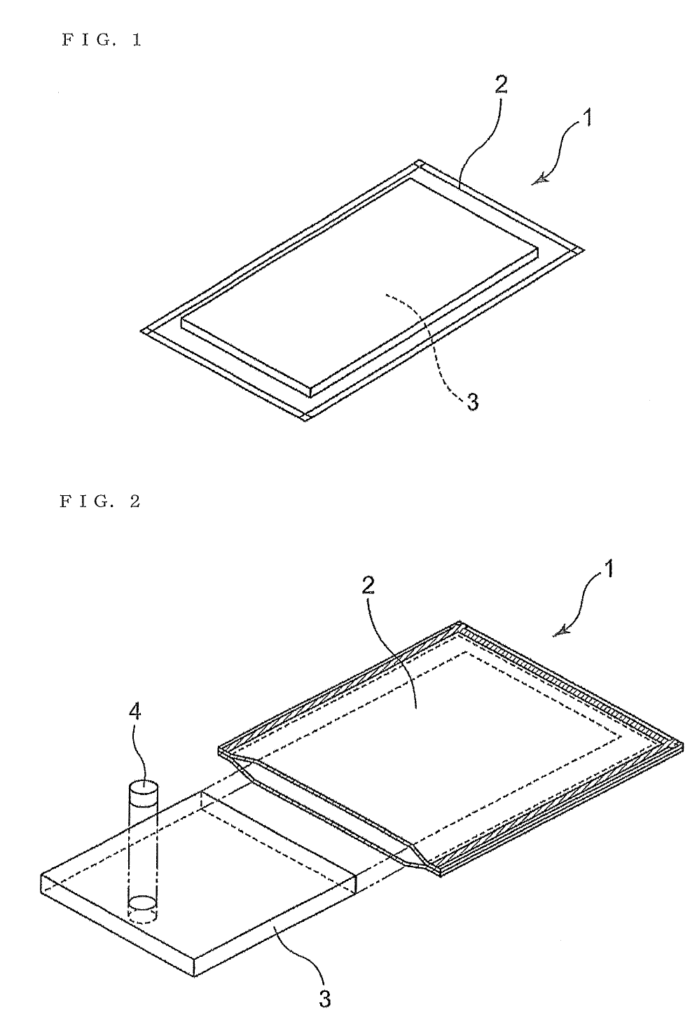

As shown in FIGS. 1 and 2, a vacuum thermal insulator 1 according to Embodiment 1 of the present invention includes a gas barrier container 2 having an air barrier property, (hereinafter referred to as the “enveloping member”), a core member 3 enclosed in the enveloping member 2, and a gas adsorbent 4. The pressure in the enveloping member 2 is reduced to a predetermined degree of vacuum.

The enveloping member 2 of the vacuum thermal insulator 1 is composed of a plastic laminate film including nylon, aluminum-deposited PET, an aluminum foil, and high-density polyethylene, and having a gas barrier property. In addition, when a laminate film which does not include an aluminum foil is used such as polypropylene, polyvinyl alcohol, and polypropylene and, it is possible to suppress a decrease in thermally insulating performance due to a thermal bridge. Furthermore, three out of four sides of the enveloping member 2 are heat-sealed.

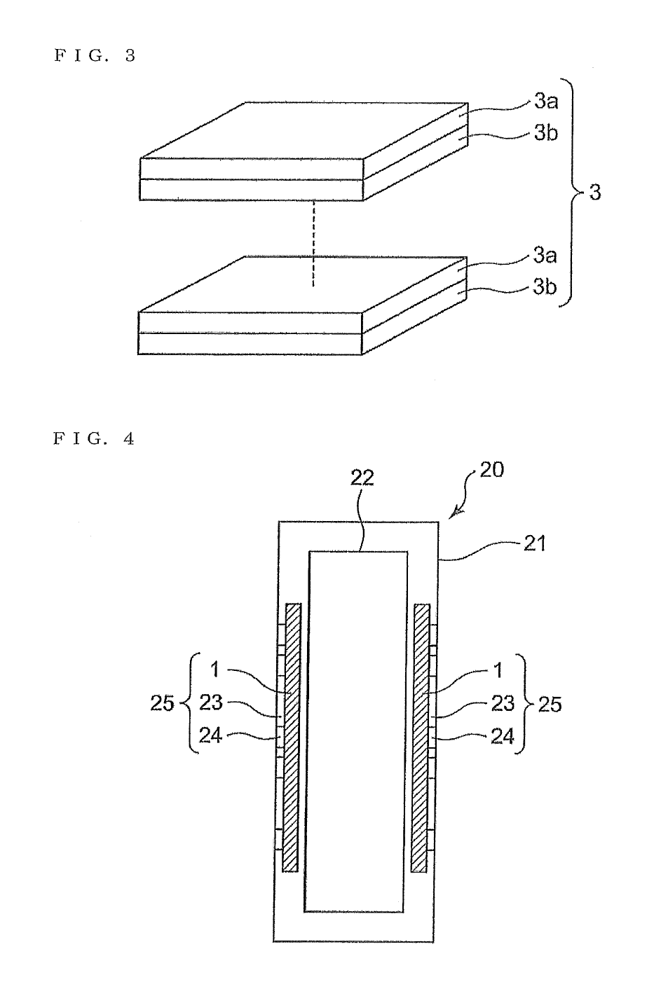

The core member 3 enclosed in the enveloping member 2 is constituted by a sheet assembly in which, for example, two types of fiber aggregates 3a and 3b composed of different materials are stacked alternately sheet by sheet as shown in FIG. 3.

That is, organic fiber aggregates 3a (first fiber aggregates), each obtained by forming fibers composed of an organic material into a sheet-like shape, and fiber aggregates 3b (second fiber aggregates), each obtained by forming fibers composed of a material having a higher tensile modulus (i.e., having higher stiffness) than the material for the organic fiber aggregates 3a, are stacked alternately sheet by sheet to produce the sheet assembly, which is used as the core member 3. In this case, preferably, the organic fiber aggregate 3a (first fiber aggregate) is an aggregate in which continuous organic fibers are formed into a sheet-like shape.

The material for the first fiber aggregates 3a is an organic material, and may be polyester or polypropylene, which is generally widely used as fibers and which intrinsically has low thermal conductivity. Consequently, when the first fiber aggregates 3a composed of polyester or polypropylene are stacked with fibers composed of a material having a high tensile modulus, thermally insulating performance can be improved. Other examples of the material for the first fiber aggregates 3a include polystyrene, polylactic acid, aramid, and LCP (liquid crystal polymer). Polystyrene has low solid heat conduction and high stiffness as an organic material, and thus has good shape retention when vacuum-packaged and subjected to atmospheric pressure. Consequently, when the first fiber aggregates 3a composed of polystyrene are stacked with fibers composed of a material having a high tensile modulus, the void ratio can be increased, and thermally insulating performance can be improved. Furthermore, since polylactic acid is biodegradable, fibers, which have been demolished and separated after use of the product, can be disposed of in a landfill. Furthermore, aramid and LCP have high stiffness, and thus have good shape retention when vacuum-packaged and subjected to atmospheric pressure. Consequently, when the first fiber aggregates 3a composed of aramid or LCP are stacked with fibers composed of a material having a high tensile modulus, the void ratio can be increased, and thermally insulating performance can be improved.

The second fiber aggregates 3b are composed of a material which has a higher tensile modulus than the material for the first fiber aggregate 3a (organic fiber aggregates), and composed of glass which is generally widely used as inorganic fibers. Furthermore, the material for the second fiber aggregates 3b is not limited to inorganic fibers, such as glass, and a material which has a higher tensile modulus than the material for the first fiber aggregates 3a (organic fiber aggregates) may be used. The second fiber aggregates 3b may be composed of an organic fiber material.

Examples of the sheet assembly in which the first fiber aggregates 3a and the second fiber aggregates 3b are combined include a sheet assembly in which first fiber aggregates 3a composed of polypropylene fibers and second fiber aggregates 3b composed of glass fibers are combined, a sheet assembly in which first fiber aggregates 3a composed of polyester fibers and second fiber aggregates 3b composed of glass fibers are combined, and a sheet assembly in which first fiber aggregates 3a composed of polypropylene fibers and second fiber aggregates 3b composed of polyester fibers are combined.

The case where the fiber aggregates (first fiber aggregates 3a and the second fiber aggregates 3b) composed of different materials are stacked alternately sheet by sheet has been described above. However, the present invention is not limited thereto, and stacking may be performed in a random manner. Examples of random stacking include, in addition to the case where the first fiber aggregates 3a and the second fiber aggregates 3b are stacked alternately sheet by sheet as described above, a case where the first fiber aggregates 3a and the second fiber aggregates 3b are stacked alternately every several sheets, or a case where the first fiber aggregates 3a and the second fiber aggregates 3b are stacked alternately sheet by sheet first, and every several sheets are stacked from the middle. In short, any number of sheets may be continuously stacked for fiber aggregates composed of one material (either the first fiber aggregates 3a or the second fiber aggregates 3b), and the number of sheets may change in the middle of the stacking operation. Furthermore, the numbers of sheets for the two types of fiber aggregates (the first fiber aggregates 3a and the second fiber aggregates 3b) may not necessarily be the same.

A method of producing a vacuum thermal insulator 1 configured as described above will be described below. First, a manufacturing process of fiber aggregates (a sheet assembly) constituting a core member 3 will be described.

First fiber aggregates 3a (e.g., organic fiber aggregates, such as polyester fibers or polypropylene fibers) are formed by allowing a thermally molten resin to fall freely onto a conveyor from nozzles which are arranged in a line transversely, and then performing winding. The nozzles are arranged in a line transversely with respect to the width to be formed, and the conveyor moves at an arbitrary speed to wind the thermally molten resin which has fallen freely from the nozzles. The bulk density of the fiber aggregates can be adjusted by changing the ejection amount of the molten resin and the speed of the conveyor. Thus, it is possible to obtain fiber aggregates having different thicknesses.

When the second fiber aggregates 3b are, for example, fiber aggregates of glass fibers, nonwoven fabric-like aggregates are produced using a wet papermaking process. In addition, when the second fiber aggregates 3b are, for example, fiber aggregates of polyester fibers, the second fiber aggregates 3b are formed by the same method as the first fiber aggregates 3a.

The first and second fiber aggregates 3a and 3b thus obtained are cut and a core member 3 is formed.

Next, a step of forming an enveloping member 2 of the vacuum thermal insulator 1 will be described. The enveloping member 2 of the vacuum thermal insulator 1 is formed using a plastic laminate film having a gas barrier property, for example, including nylon (15 μm), aluminum-deposited PET (12 μm), an aluminum foil (6 μm), and high-density polyethylene (50 μm). In addition, a laminate film which does not include an aluminum foil, such as polypropylene, polyvinyl alcohol, and polypropylene may be used. Three out of four sides of the enveloping member 2 are heat-sealed by a seal packaging machine.

Next, a vacuum packaging step will be described. The core member 3 is inserted into the enveloping member 2 which is a bag, and the enveloping member 2 is fixed such that the remaining one side is kept open and dried in a thermostatic chamber, for example, at a temperature of 100° C. for half a day (about 12 hours). Then, a gas adsorbent 4 is inserted into the enveloping member 2 in order to adsorb remaining gas after vacuum packaging, gas by outgassing from the core member 3 released over time, and gas permeating through a seal layer of the enveloping member 2. Vacuum drawing is performed, for example, using a Kashiwagi vacuum packaging machine (manufactured by NPC Incorporated; KT-650). The vacuum drawing is performed, for example, until a degree of vacuum in the chamber reaches about 1 to 10 Pa, and then, the opening of the enveloping member 2 is heat-sealed in the chamber.

Thereby, a plate-like vacuum thermal insulator 1 is obtained.

The vacuum thermal insulator 1 produced as described above is constituted by a composite body in which organic fiber aggregates 3a having low thermal conductivity and fiber aggregates 3b having high stiffness (high tensile modulus) are stacked. Furthermore, compared with powder, films, or the like, the forms and fibers of the fiber aggregates 3a and 3b can improve the thermally insulating performance of the composite body by taking advantages of each of the fiber aggregates 3a and 3b. Therefore, by constituting a composite body as in the present invention, the void ratio of the organic fiber aggregates 3a having low thermal conductivity can be improved, and advantages of both types of fiber aggregates produce a synergistic effect to improve thermally insulating performance.

### EXPERIMENTAL EXAMPLES

A thermally molten polyester or polypropylene resin was allowed to fall freely onto a conveyor from nozzles which were arranged in a line transversely, and the resin was wound while moving the conveyor. Thereby, polyester fibers or polypropylene fibers were produced. Furthermore, glass fibers were formed into nonwoven fabric-like aggregates by a wet papermaking process. The resulting fiber aggregates were cut into an A4 size, and core members 3 were formed.

Specifications of the core members used are shown in Table 1 below.

TABLE 1

| | | Thermal conductivity | Tensile modulus | Number of | Areal weight | Average fiber |
|---|---|---|---|---|---|---|
| | Material | of material W/mK | of material GPa | sheets stacked | g/m² | diameter μm |
| Example 1 | Poly-propylene | 0.117 | 1.032 to 1.720 | 25 | 12 | 15 |
| | Glass | 0.76 | 71.6 | 25 | 30 | 10 |
| Example 2 | Polyester | 0.14 | 2.8 to 4.1 | 25 | 12 | 15 |
| | Glass | 0.76 | 71.6 | 25 | 30 | 10 |
| Example 3 | Poly-propylene | 0.117 | 1.032 to 1.720 | 25 | 12 | 15 |
| | Polyester | 0.14 | 2.8 to 4.1 | 25 | 12 | 15 |
| Comparative | Poly-propylene | 0.117 | 1.032 to 1.720 | 50 | 12 | 15 |
| Example 1 | | | | | | |
| Comparative | Polyester | 0.14 | 2.8 to 4.1 | 50 | 12 | 15 |
| Example 2 | | | | | | |
| Comparative | Glass | 0.76 | 71.6 | 50 | 30 | 10 |
| Example 3 | | | | | | |

In Table 1, the average fiber diameter was defined as the average of values measured at ten locations using a microscope. The areal weight was calculated as the weight per unit area of a sheet. With respect to the thermal conductivity (W/mK) and tensile modulus (GPa) of the material, “Plastic Data Book”, published by Kogyo Chosakai Publishing, Inc., was referred to for polypropylene and polyester, and “Netsu dentatsu no kiso to enshu (Heat transfer basics and exercises)”, published by Tokai University Press, was referred to for glass. In this case, the tensile modulus of the material can be considered as the index of stiffness of the material.

As shown in Table 1, in polypropylene, the thermal conductivity (W/mK) of the material is 0.117, and the tensile modulus (GPa) of the material is 1.032 to 1.720. In polyester, the thermal conductivity (W/mK) of the material is 0.14, and the tensile modulus (GPa) of the material is 2.8 to 4.1. In glass, the thermal conductivity (W/mK) of the material is 0.76, and the tensile modulus (GPa) of the material is 71.6.

In Example 1, 25 sheets each of fiber aggregates composed of polypropylene (areal weight: 12 g/m², average fiber diameter: 15 μm) and fiber aggregates composed of glass (areal weight: 30 g/m², average fiber diameter: 10 μm), 50 sheets in total, were stacked to produce a sheet assembly. In Example 2, 25 sheets each of fiber aggregates composed of polyester (areal weight: 12 g/m², average fiber diameter: 15 μm) and fiber aggregates composed of glass (areal weight: 30 g/m², average fiber diameter: 10 μm), 50 sheets in total, were stacked to produce a sheet assembly. In Example 3, 25 sheets each of fiber aggregates composed of polypropylene (areal weight: 12 g/m², average fiber diameter: 15 μm) and fiber aggregates composed of polyester (areal weight: 12 g/m², average fiber diameter: 15 μm), 50 sheets in total, were stacked to produce a sheet assembly.

In Comparative Example 1, 50 sheets of fiber aggregates composed of polypropylene (areal weight: 12 g/m², average fiber diameter: 15 μm) were stacked to produce a sheet assembly. In Comparative Example 2, 50 sheets of fiber aggregates composed of polyester (areal weight: 12 g/m², average fiber diameter: 15 μm) were stacked to produce a sheet assembly. In Comparative Example 3, 50 sheets of fiber aggregates composed of glass (areal weight: 30 g/m², average fiber diameter: 10 μm) were stacked to produce a sheet assembly.

In addition, although the fibers (polypropylene and polyester) with a fiber diameter of 15 μm are used in Examples 1 to 3, a smaller fiber diameter is better in terms of thermally insulating performance. Theoretically, it is desirable to have a fiber diameter of 10 μm or less. Furthermore, the number of sheets to be stacked can be arbitrarily set on the basis of the thickness of the fiber aggregates and the thickness of the vacuum thermal insulator 1 to be produced.

In Examples 1 to 3 and Comparative Examples 1 to 3, in order to determine thermally insulating performance, using a thermal conductivity tester (AutoA HC-073, manufactured by ECO Instruments Co., Ltd.), thermal conductivity with a temperature difference (upper temperature: 37.7° C., lower temperature 10.0° C.) was measured. The measurement was conducted one day after the vacuum drawing step. The thermally insulating performance ratio as the vacuum thermal insulator 1 is expressed by the value obtained by dividing the thermal conductivity of Comparative Example 2 by the thermal conductivity of each of Examples 1, 2, and 3 and Comparative Examples 1 and 3 (equal to the reciprocal of the value obtained by dividing the thermal conductivity of each of Examples 1, 2, and 3 and Comparative Examples 1 and 3 by the thermal conductivity of Comparative Example 2). The void ratio is the value obtained by dividing the weight of the core member 3 by the volume of the core member 3 (core member width×core member length×core member thickness, which corresponds to the value obtained by subtracting twice the thickness of the enveloping member 2 from the thickness of the vacuum thermal insulator 1), dividing the resulting value by the solid density of the core member 3, and subtracting the resulting quotient from 1. The experimental results are shown in Table 2 below.

TABLE 2

| | | Thermally insulating | |
|---|---|---|---|
| | | performance ratio as | |
| | Material | vacuum thermal insulator | Void ratio % |
| Example 1 | Polypropylene | 1.0 | 87 |
| | Glass | | |
| Example 2 | Polyester | 1.1 | 87 |
| | Glass | | |
| Example 3 | Polypropylene | 1.1 | 82 |
| | Polyester | | |
| Comparative | Polypropylene | 0.7 | 79 |
| Example 1 | | | |
| Comparative | Polyester | 1.0 | 84 |
| Example 2 | | | |
| Comparative | Glass | 0.9 | 92 |
| Example 3 | | | |

### Example 1

As is evident from the experimental results, in the case where the vacuum thermal insulator 1 is constituted by the composite sheet including polypropylene and glass (Example 1, the thermally insulating performance ratio as the vacuum thermal insulator: 1.0), the thermally insulating performance is better than the case where the vacuum thermal insulator 1 is constituted by the sheet composed of polypropylene only (Comparative Example 1, the thermally insulating performance ratio as the vacuum thermal insulator: 0.7) or the sheet composed of glass only (Comparative Example 3, the thermally insulating performance ratio as the vacuum thermal insulator: 0.9).

Glass (void ratio: 92%, tensile modulus: 71.6 GPa) has a higher void ratio and a higher tensile modulus than polypropylene (void ratio: 79%, tensile modulus: 1.032 to 1.720 GPa), and thus glass has high stiffness and does not easily bend, resulting in high performance. In contrast, polypropylene (void ratio: 79%, tensile modulus: 1.032 to 1.720 GPa) easily bends because of its low tensile modulus and has a low void ratio, resulting in low performance. However, since the two types of materials are alternately stacked, polypropylene which easily bends becomes not easily to bend, and the void ratio increases (from 79% to 87%). Since the thermal conductivity of polypropylene is intrinsically low, the performance improves compared with the case of glass only (the thermally insulating performance ratio as the vacuum thermal insulator improves to 1.0 when polypropylene and glass are alternately stacked while the thermally insulating performance ratio as the vacuum thermal insulator is 0.7 for polypropylene and 0.9 for glass).

### Example 2

As is evident from the experimental results, in the case where the vacuum thermal insulator 1 is constituted by the composite sheet including polyester and glass (Example 2, the thermally insulating performance ratio as the vacuum thermal insulator: 1.1), the thermally insulating performance is better than the case where the vacuum thermal insulator 1 is constituted by the sheet composed of polyester only (Comparative Example 2, the thermally insulating performance ratio as the vacuum thermal insulator: 1.0) or the sheet composed of glass only (Comparative Example 3, the thermally insulating performance ratio as the vacuum thermal insulator: 0.9).

Glass (void ratio: 92%, tensile modulus: 71.6 GPa) has a higher void ratio and a higher tensile modulus than polyester (void ratio: 84%, tensile modulus: 2.8 to 4.1 GPa), and thus glass has high stiffness and does not easily bend, resulting in high performance. In contrast, polyester (void ratio: 84%, tensile modulus: 2.8 to 4.1 GPa) easily bends because of its low tensile modulus and has a low void ratio, resulting in low performance. However, since the two types of materials are alternately stacked, polyester which easily bends becomes not easily to bend, and the void ratio increases (from 84% to 87%). Since the thermal conductivity of polyester is intrinsically low, the performance improves compared with the case of glass only (the thermally insulating performance ratio as the vacuum thermal insulator improves to 1.1 when polyester and glass are alternately stacked while the thermally insulating performance ratio as the vacuum thermal insulator is 1.0 for polyester and 0.9 for glass).

### Example 3

As is evident from the experimental results, in the case where the vacuum thermal insulator 1 is constituted by the composite sheet including polyester and polypropylene (Example 3, the thermally insulating performance ratio as the vacuum thermal insulator: 1.1), the thermally insulating performance is better than the case where the vacuum thermal insulator 1 is constituted by the sheet composed of polyester only (Comparative Example 2, the thermally insulating performance ratio as the vacuum thermal insulator: 1.0) or the sheet composed of polypropylene only (Comparative Example 1, the thermally insulating performance ratio as the vacuum thermal insulator: 0.7).

Polyester (void ratio: 84%, tensile modulus: 2.8 to 4.1 GPa) has a higher void ratio and a higher tensile modulus than polypropylene (void ratio: 79%, tensile modulus: 1.032 to 1.720 GPa), and thus polyester has high stiffness and does not easily bend, resulting in high performance. In contrast, polypropylene (void ratio: 79%, tensile modulus: 1.032 to 1.720 GPa) easily bends because of its low tensile modulus and has a low void ratio, resulting in low performance. However, since the two types of materials are alternately stacked, polypropylene which easily bends becomes not easily to bend, and the void ratio increases (from 79% to 82%). Since the thermal conductivity of polypropylene is intrinsically low, the performance improves compared with the case of polyester only (the thermally insulating performance ratio as the vacuum thermal insulator improves to 1.1 when polypropylene and polyester are alternately stacked while the thermally insulating performance ratio as the vacuum thermal insulator is 0.7 for polypropylene and 1.0 for polyester).

### Embodiment 2

### Refrigerator

FIG. 4 is a cross-sectional view showing a thermally insulating box according to Embodiment 2 (specifically, a refrigerator). Referring to FIG. 4, a refrigerator 20 which is a thermally insulating box includes an outer box 21, an inner box 22 disposed inside the outer box 21, a vacuum thermal insulator 1 and polyurethane foam (thermal insulator) 23 which are disposed between the outer box 21 and the inner box 22, and a freezing unit (not shown) which feeds cold air into the inner box 22. The outer box 21 and the inner box 22 have openings in a common face side (not shown), and a door (not shown) is provided in the openings. The internal temperature of the inner box 22 is controlled by a temperature controller.

In the refrigerator, since an enveloping member 2 of the vacuum thermal insulator 1 includes an aluminum foil, a thermal bridge may occur in which heat flows through the aluminum foil into the inside. Therefore, in order to suppress the influence of the thermal bridge, the vacuum thermal insulator 1 is disposed apart from the coated steel plate of the outer box 21, using a spacer 24 composed of a molded resin. Note that holes are appropriately provided in the spacer 24 in order to facilitate flow of the polyurethane foam which is injected into the space of a thermal insulation wall in a later step so that voids can be prevented from remaining in the polyurethane foam.

That is, the refrigerator 20 has a thermal insulation wall 25 constituted by the vacuum thermal insulator 1, the spacer 24, and the polyurethane foam 23. The region where the thermal insulation wall 25 is provided is not limited. The thermal insulation wall 25 may be disposed entirely or partially in the space between the outer box 21 and the inner box 22, and may be disposed inside the door.

When the refrigerator 20 configured as described above becomes a used refrigerator, it is dismantled and recycled at a local recycling center in accordance with the Home Appliance Recycling Law. Since the refrigerator 20 has the vacuum thermal insulator 1 including the core member 3 composed of fiber aggregates, the refrigerator body can be directly crushed without removing the vacuum thermal insulator 1. In particular, in the case where the fiber aggregates are composed of only organic fibers, in thermal recycling, combustion efficiency is not reduced, or residues do not occur. Thus, high recyclability can be obtained.

In the case where the core member of a vacuum thermal insulator is composed of inorganic powder instead of fiber aggregates as in the present invention, the powder scatters when the refrigerator body is directly crushed. Therefore, it is necessary to remove the vacuum thermal insulator from the refrigerator body, which is very troublesome.

The case where the thermally insulating box is the refrigerator 20 has been described above. However, the present invention is not limited thereto, and may be applied to equipment for cooling or heating, such as storehouses equipped with thermal insulation, vehicle air conditioners, and water heaters. Furthermore, thermally insulating bags (thermally insulating containers) including deformable outer bags and inner bags may be used instead of boxes having a predetermined shape.
1: VACUUM THERMAL INSULATOR
2: ENVELOPING MEMBER (GAS VARRIER CONTAINER)
3: CORE MEMBER
3a: ORGANIC FIBER AGGREGATE (FIRST FIBER AGGREGATE)
3b: FIBER AGGREGATE (SECOND FIBER AGGREGATE)
20: REFRIGERATOR
21: OUTER BOX
22: INNER BOX
23: POLYURETHANE FOAM (THERMAL INSULATOR)
24: SPACER

What is claimed is:

1. A vacuum thermal insulator comprising:
a container having a gas barrier property; and
a core member placed in said container, said container being sealed such that the interior of said container is in a reduced pressure state,
wherein said core member is constituted by a sheet assembly in which organic fiber aggregates, each obtained by forming fibers composed of an organic material into a sheet-like shape, and fiber aggregates, each obtained by forming fibers composed of a material having a higher tensile modulus than the material for said organic fiber aggregates into a sheet-like shape, are randomly stacked.

2. The vacuum thermal insulator of claim 1, wherein the fibers of said organic fiber aggregates are continuous fibers.

3. The vacuum thermal insulator of claim 1, wherein said organic fiber aggregates and said fiber aggregates are stacked alternately sheet by sheet.

4. The vacuum thermal insulator of claim 1, wherein said organic fiber aggregates and said fiber aggregates are stacked alternately every several sheets.

5. The vacuum thermal insulator of claim 1, wherein said organic fiber aggregates and said fiber aggregates are stacked alternately sheet by sheet first, and every several sheets from the middle of the stacking.

6. The vacuum thermal insulator of claim 1, wherein the fiber material for said organic fiber aggregates or said fiber aggregates is any one of polyester, polypropylene, polystyrene, polylactic acid, aramid, LCP, and glass.

7. The vacuum thermal insulator of claim 1, wherein the fiber material for said organic fiber aggregates is polypropylene, and the fiber material for said fiber aggregates is glass.

8. The vacuum thermal insulator of claim 1, wherein the fiber material for said organic fiber aggregates is polyester, and the fiber material for said fiber aggregates is glass.

9. The vacuum thermal insulator of claim 1, wherein the fiber material for said organic fiber aggregates is polypropylene, and the fiber material for said fiber aggregates is polyester.

10. The vacuum thermal insulator of claim 1, wherein an average fiber diameter of said organic fiber aggregates and said fiber aggregates is 15 μm or less.

11. A thermally insulating box comprising:
an outer box; and
an inner box which is disposed inside said outer box,
wherein the vacuum thermal insulator of claim 1 is disposed between said outer box and said inner box.

12. The thermally insulating box of claim 11, wherein a thermal insulator is provided to fill a space between said outer box and said vacuum thermal insulator and/or a space between said inner box and said vacuum thermal insulator.

13. The thermally insulating box of claim 11, wherein a spacer is disposed between said outer box and said vacuum thermal insulator.

14. The thermally insulating box of claim 11, wherein the internal temperature of said inner box is controlled by a temperature controller.

15. The vacuum thermal insulator of claim 2, wherein said organic fiber aggregates and said fiber aggregates are stacked alternately sheet by sheet.

16. The vacuum thermal insulator of claim 2, wherein said organic fiber aggregates and said fiber aggregates are stacked alternately every several sheets.

17. The vacuum thermal insulator of claim 2, wherein said organic fiber aggregates and said fiber aggregates are stacked alternately sheet by sheet first, and every several sheets from the middle of the stacking.

18. The vacuum thermal insulator of claim 2, wherein the fiber material for said organic fiber aggregates or said fiber aggregates is any one of polyester, polypropylene, polystyrene, polylactic acid, aramid, LCP, and glass.

19. The vacuum thermal insulator of claim 2, wherein an average fiber diameter of said organic fiber aggregates and said fiber aggregates is 15 μm or less.
